(19) United States
(12) Patent Application Publication
(10) Pub. No.: US 2013/0168314 A1
(43) Pub. Date: Jul. 4, 2013

(54) Method for Treating Wastewater Containing Copper Complex

(71) Applicants: PEKING UNIVERSITY FOUNDER GROUP CO. LTD., Beijing (CN); ZHUHAI FOUNDER TECH. MULTILAYER PCB CO., LTD., Zhuhai City (CN); ZHUHAI FOUNDER PCB DEVELOPMENT CO., LTD., Zhuhai City (CN)

(72) Inventor: Bo ZHOU, Beijing (CN)

(73) Assignees: PEKING UNIVERSITY FOUNDER GROUP CO., LTD., Beijing (CN); ZHUHAI FOUNDER PCB DEVELOPMENT CO., LTD., Zhuhai City (CN); ZHUHAI FOUNDER TECH. MULTILAYER PCB CO., LTD., Zhuhai City (CN)

(21) Appl. No.: 13/730,444

(22) Filed: Dec. 28, 2012

(30) Foreign Application Priority Data
Dec. 28, 2011 (CN) 201110447955.8

(51) Int. Cl. C02F 1/62

(52) U.S. Cl. CPC C02F 1/62
USPC 210/605; 210/719; 210/631

(57) ABSTRACT

Disclosed is a method for treating wastewater containing at least one copper complex, comprising: 1) providing the wastewater containing the at least one copper complex, wherein the at least one copper complex is chosen from EDTA-Cu²⁺ complex and ammonia-Cu²⁺ complex; 2) adjusting pH of the wastewater containing the at least one copper complex to be within a range from 2.0 to 3.0, and adding ferrous sulfate to convert copper in the wastewater into a form of cuprous ions; and 3) adjusting pH of the wastewater obtained in step 2) to be within a range from 8.0 to 10.5, so that the cuprous ions in the wastewater are converted into precipitates of cuprous hydroxide and/or precipitates of cuprous oxide.

### RELATED APPLICATIONS

This application claims the benefit of Chinese Patent Application No. 201110447955.8, filed with the State Intellectual Property Office on Dec. 28, 2011, the content of which is hereby incorporated by reference in its entirety.

### FIELD

The disclosure relates to the field of a process for treating circuit board wastewater, for example, to a method for treating wastewater containing at least one copper complex.

### BACKGROUND

With the rapid development of electronic product manufacturing industry, both yield and production scale of circuit boards have been gradually increased, and the amount of wastewater discharged thereby in large and medium-sized professional production plants is about 1000-20000T/D. In accordance with the primary discharge standard of Integrated Wastewater Discharge Standard (DB44-26) in PRC (People's Republic of China), pH is required to be within a range from 6 to 9; COD (Chemical Oxygen Demand) is required to be no more than 90 mg/l; and Cu²⁺ is required to be no more than 0.5 mg/l.

The circuit board industry, including traditional single sided boards, double-sided boards, multi-layer boards, high-density interconnection boards, and packaging machine boards, can discharge wastewater containing major pollutants such as Cu²⁺-based heavy metal ions and organic substances that are not readily biodegradable. The Cu²⁺-containing wastewater mainly includes: EDTA-Cu²⁺ containing wastewater discharged from PTH (Plated Through Hole) (chemical copper) lines, ammonia-Cu²⁺ containing wastewater discharged from etching lines, and low copper-containing wastewater discharged from pre-treatment. Among them, copper in the EDTA-Cu²⁺ containing wastewater and in the ammonia-Cu²⁺ containing wastewater exists in a complex state, which has extremely high chemical stability. Removal of copper pollutants can be fulfilled by complex breaking. Heavy metals in other types of low copper-containing wastewater can be removed by simple alkaline precipitation.

The copper in the EDTA-Cu²⁺ containing wastewater and the ammonia-Cu²⁺ containing wastewater mainly exists in a complex form, so these two types of wastewater are generally known as complex wastewater in the circuit board industry. They are treated by mixed collection, which mainly uses sulfides (e.g. sodium sulfide) for treatment, and may comprise the steps as shown in FIG. 1. In the method as illustrated by FIG. 1, treatment for heavy metals in wastewater can be relatively effective due to low solubility of sulfides. However, there can be many problems, such as high unit price of sulfides, generation of toxic hydrogen sulfide gas due to improper control during treatment, and difficulty in forming large sulfide precipitate particles. In addition, in order to achieve complete precipitation of Cu²⁺, excessive amount of sulfide needs to be added during treatment. Hence, ferrous sulfate also needs to be added at the later stage of treatment to remove the excessive amount of sulfide. Accordingly, many problems can arise, such as high cost for wastewater treatment, damage to the health of employees caused by the treatment process, unqualified wastewater treatment owing to incomplete precipitation, and water yellowness, etc.

The wastewater subjected to the copper removal treatment above, however, needs to be further treated to reduce COD thereof, and the treatment method can be biochemical treatment, for example.

Chinese Patent Application No. CN200710074651.5 discloses a complete process for treating wastewater generated from circuit board production, wherein copper containing wastewater is treated in such a manner that may include: adjustment for pH as well as reduction and replacement are performed, sodium hydroxide and calcium hydroxide are then added to adjust pH to be about 9, and finally, treatment by sodium sulfide and coagulation precipitation are performed, which is followed by treatment of a mixture comprising the so-treated wastewater and rinsing water. This method may have the following technical defects: process flow is too long and many one-time investments are required, which is disfavored for industrial production; single treatment renders poor results, so multi-treatment is needed; high-COD containing wastewater after biochemical treatment needs to be mixed with other wastewater again even if the discharge standard is satisfied, thus demanding larger subsequent investment for facility. In addition, repeated additions of a reducing agent may increase the possibility of separating out hydrogen sulfide.

### SUMMARY

To solve at least one of the above problems in the prior art, the present disclosure provides a method for treating wastewater containing at least one copper complex.

In some embodiments, the present disclosure provides:

a method for treating wastewater containing at least one copper complex, comprising:

1) providing wastewater containing at least one copper complex, wherein the at least one copper complex is chosen from EDTA-Cu²⁺ complex and ammonia-Cu²⁺ complex;

2) adjusting pH of the wastewater containing the at least one copper complex to be within a range from 2.0 to 3.0, and adding ferrous sulfate to convert copper in the wastewater into a form of cuprous ions; and

3) adjusting pH of the wastewater obtained in step 2) to be within a range from 8.0 to 10.5, so that the cuprous ions in the wastewater are converted into precipitates of cuprous hydroxide and/or precipitates of cuprous oxide.

In some embodiments, in step 3) of the method, pH of the wastewater obtained in step 2) is adjusted to be within a range from 8.5 to 9.5.

In some embodiments, at least one flocculant is added to the wastewater after the cuprous ions are converted into precipitates of cuprous hydroxide and/or precipitates of cuprous oxide, so that the precipitates obtained in the step 3) are flocculated.

In some embodiments, the at least one flocculant can be polyacrylamide.

In some embodiments, the method further comprises:

4) separating the wastewater from the precipitates obtained in the step 3).

In some embodiments, the method further comprises:

5) adjusting pH of the wastewater obtained in step 4) to be within a range from 6.0 to 9.0, and treating the wastewater by a biochemical treatment system so as to lower the COD of the wastewater to 90 mg/l or below.

In some embodiments, the biochemical treatment system comprises a facultative pond and an aerobic pond.

In some embodiments, pH of the wastewater obtained in step 4) is adjusted to be within a range from 7.0 to 7.5, and the wastewater is treated by a biochemical treatment system in order to lower the COD of the wastewater to 60 mg/l or below.

In some embodiments, the method does not use sulfide.

In some embodiments, the wastewater containing at least one copper complex is generated in a production of a circuit board.

Compared with the prior art, the method disclosed herein may have the following advantages and positive effects:

(1) compared with conventional methods, the ferrous sulfate used in the method disclosed herein can break complex more effectively, can have flocculating and decolorization effect, and is low in unit price. In addition, use of ferrous sulfate for wastewater treatment can improve the biodegradability of wastewater significantly and provide stable operation of a biochemical system effectively;

(2) the method disclosed herein can simplify the operating steps, can effectively solve the problem of secondary pollution (e.g., H₂S toxic gas) caused by use of sodium sulfide in a traditional process, and can lower the cost for wastewater treatment and guarantee safe production. In addition, treatment process control can be obtained with ease, no new equipment is required, and the method can be implemented based on limited modification on the existing treatment process. Hence, the method can be implemented in the prior process quite easily and meet the demand on large-scale industrial production; and

(3) The wastewater subjected to treatment according to the method disclosed herein can be further subjected to biochemical treatment, so that the level of copper can be stably maintained at 0.1 mg/l to 0.3 mg/l, and COD can be lowered to 60 mg/l or below. Accordingly, the wastewater can meet the discharge standards for pollutants (discharge standards in electroplating industry and primary standard of the second period required in DB44-26).

### BRIEF DESCRIPTION OF THE DRAWINGS

FIG. 1 is a schematic diagram of a conventional method for treating wastewater containing at least one copper complex; and

FIG. 2 is a schematic diagram of a method for treating wastewater containing at least one copper complex according to the present disclosure.

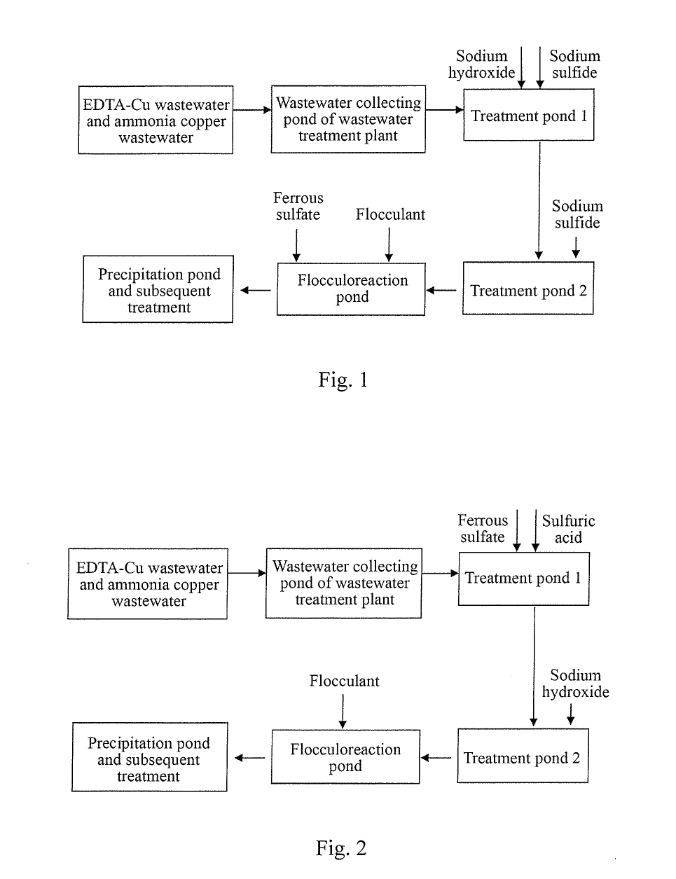

### DETAILED DESCRIPTION

Further description is made below to illustrate, but in no way to limit, the present disclosure by description of the embodiments and with reference to the accompanying drawings. In accordance with the basic concept of the present disclosure, various modifications or improvements could be made by those skilled in this art, all of which shall be considered to be within the scope of the present disclosure if they do not depart from the basic concept of the present disclosure.

The at least one copper complex containing wastewater (or referred to as complex wastewater) described herein includes mixed wastewater which can be a mixture of EDTA-Cu²⁺ containing wastewater discharged from PTH lines of a circuit board plant and ammonia-Cu²⁺ containing wastewater discharged from etching lines of the circuit board plant.

The flocculant described herein refers to a polymer, capable of forming flocculate from fine-particle solids dispersed in liquid, e.g., polyacrylamide (also referred to as PAM), polymerization ferric chloride (also referred to as PFC), and the like. Flocculant aqueous solution with a proper concentration, e.g., 2 to 5 wt. ‰, may be added as needed.

The COD described herein refers to chemical oxygen demand, and for example, refers to the amount of an oxidant consumed for oxidative decomposition of oxidable substances in water upon the action of an external strong oxidant under a certain condition. The chemical oxygen demand reflects a degree of water pollution caused by reducing substances, which include organic substances, nitrites, ferrous salts, sulfides, and the like. However, the amount of inorganic reducing substances in common water and wastewater is relatively small and pollution caused by organic substances is quite common. Thus, the COD can be regarded as a comprehensive performance indicator for relative content of organic substances.

Stability of complex compounds in complex wastewater may depend on pH. Since complex copper ions are more stable than copper hydroxide when pH is more than 3 but less than or equal to 12, copper ions may not be removed in the form of copper hydroxide precipitates by pH adjustment. The inventors found that copper can be completely separated out in the form of cuprous ions by mixing EDTA-Cu²⁺ wastewater with ammonia-Cu²⁺ wastewater, adjusting pH of the mixed wastewater to be within a range from 2.0 to 3.0, and breaking the ammonia-copper and EDTA-Cu²⁺ complexes in the wastewater by ferrous sulfate; and then, by adjusting pH of the wastewater, these cuprous ions can be converted to cuprous hydroxide and removed. The content of the copper in the wastewater treated as above can be lowered from a range from 30 mg/l to 80 mg/l to a range from 1 mg/l to 3 mg/l. However, COD may be unchanged, which may be still as high as 150 mg/l to 300 mg/l. Therefore, the so-treated wastewater may not be directly discharged and may be subjected to retreatment. The inventor also found through experiments that the quality of the wastewater treated as above can meet the entry demand of the biochemical system. Furthermore, addition of ferrous sulfate can significantly improve the biodegradability of the wastewater. Thus, after biochemical treatment, copper can be stabilized within a range from 0.1 mg/l to 0.3 mg/l and COD can be lowered to 60 mg/l or below, which indicates that the so-treated wastewater satisfies the pollutant discharge standard (primary standard in electroplating industry).

In one aspect of the present disclosure, provided is a method for treating wastewater containing at least one copper complex, comprising:

1) providing wastewater containing at least one copper complex, wherein the at least one copper complex is chosen from EDTA-Cu²⁺ complex and ammonia-Cu²⁺ complex;

2) adjusting pH of the wastewater containing the at least one copper complex to be within a range from 2.0 to 3.0, and adding ferrous sulfate to convert copper in the wastewater into a form of cuprous ions; and

3) adjusting pH of the wastewater obtained in step 2) to be within a range from 8.0 to 10.5, so that the cuprous ions in the wastewater are converted into precipitates of cuprous hydroxide and/or precipitates of cuprous oxide, wherein, for example, pH of the wastewater obtained in the step 2) is adjusted to be within a range from 8.5 to 9.5.

In step 2) thereof, pH of the wastewater may be adjusted by at least one proper acidic substance as needed. The at least one proper acidic substance can be sulfuric acid, for example.

In step 3) thereof, pH of the wastewater may be adjusted by at least one proper alkaline substance as needed. The at least one proper alkaline substance can be NaOH, lime, and the like, for example.

In some embodiments, in step 3), at least one flocculant is added into the wastewater after the cuprous ions are converted into precipitates of cuprous hydroxide and/or precipitates of cuprous oxide, so that the precipitates obtained in step 3) are flocculated (e.g., the precipitates form large particles). Flocculant aqueous solution with a proper concentration, e.g., 2 to 5 wt. ‰, may be added as needed. The at least one flocculant, for example, can be polyacrylamide.

In some embodiments, the method further comprises: 4) separating the wastewater from the precipitates obtained in step 3).

In some embodiments, the method further comprises: 5) adjusting pH of the wastewater obtained in step 4) to be within a range from 6.0 to 9.0 (wherein, pH is, for example, adjusted to be within a range from 7.0 to 7.5), and treating the wastewater by a biochemical treatment system so as to lower the COD of the wastewater to 90 mg/l or below, such as 60 mg/l or below.

The biochemical treatment system thereof may comprise a facultative pond and an aerobic pond. The facultative pond can be used to convert macromolecular organic substances into micromolecular organic substances by acidation and hydrolysis reactions of anaerobic bacteria in the facultative pond; and the aerobic pond can be used to decompose the micromolecular organic substances into carbon dioxide and water by aerobic organisms.

For example, the method of the present disclosure does not use sulfide such as sodium sulfide.

For example, the wastewater containing copper complex treated in the method disclosed herein is wastewater generated in the production of a circuit board.

An exemplary implementation of the present disclosure will be described below with reference to FIG. 2:

(1) Segregation and Independent Collection for Wastewater

In general, classified discharge from production lines is employed in wastewater treatment, especially for relatively complicated wastewater in circuit board industry, and such classified and segregated discharge may help to meet the discharge standard upon subsequent treatments. Thus, segregation and independent collection for such wastewater can be performed on production lines, and a collecting pond can have certain functions such as buffering and homogenization.

The method for treating wastewater containing copper complex provided by the disclosure is, for example, directed at the treatment of EDTA-Cu²⁺ and ammonia-Cu²⁺ containing wastewater in which heavy metal copper exists in a complex state. Complex breaking may be needed for removing the copper pollutant. Other low copper-containing wastewaters can be segregated independently, and then the heavy metal contained therein can be removed by simple alkaline precipitation. The segregation has the advantage that no more than one-time investment is required in actual production process.

(2) Adjustment of Wastewater to an Acidic State and Addition of Ferrous Sulfate for Complex Breaking

Divalent iron ions in ferrous sulfate have a reduction property and can reduce divalent copper ions (Cu²⁺) in water into monovalent copper ions (Cu⁺) when pH is 2 to 3, and the bonding of these monovalent copper ions with ammonia and EDTA is no longer stable:

a) Treatment process: EDTA-Cu²⁺ wastewater and ammonia-Cu²⁺ wastewater are pumped into a treatment pond 1 by a lifting pump; stirring is started automatically; sulfuric acid is added to the treatment pond 1 by means of automatic pH control in order to adjust pH of the wastewater, while ferrous sulfate is added to the wastewater; and complete reaction is implemented under pH controlled within a range from 2 to 3.

b) Reaction mechanism:

[Cu(NH₃)]₄²⁺+Fe²⁺→Cu⁺+Fe³⁺+4NH₃

[Cu(EDTA)]²⁺+Fe²⁺→Cu⁺+Fe³⁺+EDTA

(3) Cuprous Ions Precipitated by Alkaline Adjustment

Since the bonding of the monovalent copper ions with ammonia and EDTA is less stable, these monovalent copper ions can react with hydroxide radicals to generate precipitates of cuprous hydroxide, and the precipitates of cuprous hydroxide can be further dehydrated to generate cuprous oxide:

a) Treatment process: wastewater subjected to complex breaking enters a treatment pond 2, sodium hydroxide is added to the treatment bond 2 by means of automatic pH control to adjust pH of the wastewater, thereby controlling pH within a range, for example, from 8.5 to 9.5, and correlation of stirring with the lifting pump is realized by automatic PLC correlation control.

b) Reaction mechanism:

Cu⁺+OH⁻→CuOH→Cu₂O

(4) Flocculation and Precipitation

The cuprous hydroxide can rapidly form large particles in a flocculoreaction pond under the reaction with a flocculant.

(5) Separation of Pollutants

Large particles enter a precipitation pond for the purpose of solid-liquid separation.

(6) Subsequent Treatment

The purpose of subsequent treatment is to reduce the COD of the wastewater treated as above, so that the wastewater can meet the discharge standards. The wastewater treated above can be then treated by, for example, a biochemical treatment system, which may be a facultative pond (also referred to as facultative biochemical pond) and/or an aerobic pond (also referred to as aerobic biochemical pond). In some embodiments, the supernatant wastewater (after separating out the precipitates) is subjected to the procedures of sequentially entering a pH adjustment pond, a facultative pond, an aerobic pond, an alkali-added flocculation pond, a precipitation pond, a pH back-adjustment pond, and discharging the treated wastewater meeting the discharge standards. The precipitate concentrated mud can be continuously treated, and copper in the wastewater is effectively treated thereby.

The present disclosure can be further explained or described below by reference to examples that, however, shall not be considered as limitation to the scope of the present disclosure.

The scheme of continuous treatment can be adopted in the examples below, so the components added are represented in percentages, for example, rather than specific numerical values. However, the present disclosure is not limited to this scheme, for example, the scheme of batched treatment may also be adopted, and in the case of batched treatment, the required addition amount of each of the components can be determined by, for example, corresponding conversions of the above percentages.

The EDTA-Cu²⁺ wastewater and the ammonia-Cu²⁺ wastewater in the examples below are EDTA-Cu²⁺ wastewater and ammonia-Cu²⁺ wastewater respectively discharged from PTH lines and etching lines of Zhuhai Founder Multi-layer PCB Co., Ltd., but the present disclosure is not limited to this, and EDTA-Cu²⁺ wastewater and ammonia-Cu²⁺ wastewater from other sources may also be treated according to the method disclosed herein.

### Example 1

EDTA-Cu²⁺ wastewater discharged from a PTH line and ammonia-Cu²⁺ wastewater discharged from an etching line were continuously pumped into a treatment pond 1 by a lifting pump at the rate of 50 m³/h and then continuously stirred in a mechanical manner at the rate of 60 rpm/min, where copper content in the wastewater was 60 mg/l and COD was 200 mg/1.

Management and control in the following operations were carried out using an ST-300 Siemens PLC automatic management and control system. PH was adjusted to 2 by means of automatic pH control and simultaneously 10 wt. % of ferrous sulfate was added to the treatment pond 1 at the rate of 20 L/min; the wastewater entered a treatment pond 2 after complete reaction and complex breaking; sodium hydroxide was then added to the treatment pond 2 by means of automatic pH control to adjust pH of the wastewater, where pH was controlled to remain at 8.5 and the stirring rate was 60 rpm/min. The wastewater after alkaline adjustment entered a flocculoreaction pond and a flocculant, i.e., 3 wt. % of PAM aqueous solution was added to the flocculoreaction pond to form large particles rapidly, and these large particles were subjected to solid-liquid separation in a precipitation pond. The wastewater discharged from the precipitation pond after treatment had a copper content of 1.5 mg/l and a fundamentally unchanged COD.

The above procedures were controlled to be continuously performed, so precipitation effects, including the size of precipitate particles and whether the supernatant was clear and transparent, needed to be inspected frequently, and increase of the addition amount of the flocculant PAM was needed if the size of particles was too small, and increase of the addition amount of the ferrous sulfate was needed in the case of abnormal water color, so as to ensure complete treatment for copper complex.

The supernatant wastewater from the precipitation pond was subjected to the following procedures for treatment: at first, the wastewater entered a pH adjustment pond to adjust pH to be in a range from 7.0 to 7.5; secondly, the wastewater entered a biochemical system to convert macromolecular organic substances in the wastewater into micromolecular organic substances by acidation and hydrolysis actions of facultative bacteria in a facultative pond, after that, the wastewater entered an aerobic pond to convert these micromolecular organic substances into inorganic substances (carbon dioxide and water) by metabolism action of aerobic bacteria, so as to remove the majority of COD in the wastewater; afterwards, the wastewater entered an organic wastewater reaction pond for coagulation precipitation once again and entered an organic precipitation pond for solid-liquid separation so as to remove a large number of aging organisms floating in the wastewater, and finally, the wastewater entered a pH back-adjustment pond to ensure pH thereof to be within a discharge control range from 8 to 8.5 and was further discharged as treated wastewater that met the standard. Therefore, copper in the wastewater was effectively treated. In this case, copper content in the wastewater was 0.2 mg/l and COD was 35 mg/l, which met the pollutant discharge standards.

It was found based on comparison between Example 1 and CN200710074651.5 that: there can be many shortcomings in CN200710074651.5 such as complicated treatment procedures, too much management and control at chemical addition points, significant defects in sodium sulfide treatment, use of electrocatalytic oxidation method in both developing wastewater and cyanide-containing wastewater, and complexity of treatment procedure superimpositions. Furthermore, the wastewater after biochemical treatment also needs to be mixed with other types of wastewater for the purpose of retreatment, which leads to a higher requirement on the treatment capacity of subsequent treatment facilities and is accordingly unfavorable for industrial production. Thus, the present disclosure can realize an implementation effect that may not be achieved by the design scheme of CN200710074651.5.

### Example 2

EDTA-Cu²⁺ wastewater discharged from PTH lines and ammonia-Cu²⁺ wastewater discharged from etching lines were continuously pumped into a treatment pond 1 by a lifting pump at the rate of 30 m³/h and then continuously stirred in a mechanical manner at the rate of 60 rpm/min, where copper content in the wastewater was 60 mg/l and COD was 200 mg/1.

Management and control in the following operations were carried out using an ST-300 Siemens PLC automatic management and control system. PH was adjusted to 3 by means of automatic pH control and simultaneously 10 wt. % of ferrous sulfate was added to the treatment pond 1 at the rate of 10 L/min; the wastewater entered a treatment pond 2 after complete reaction and complex breaking; sodium hydroxide was then added to the treatment pond 2 by means of automatic pH control to adjust pH of the wastewater, where pH was controlled at 9.5 and the stirring rate was 60 rpm/min. The wastewater subsequent to alkaline adjustment entered a flocculoreaction pond; a flocculant, i.e. 2 wt. % of PAM aqueous solution was added to the flocculoreaction pond so as to form large particles rapidly; and these large particles were subjected to solid-liquid separation in a precipitation pond. The wastewater discharged from the precipitation pond after treatment had a copper content of 1.4 mg/l and a nearly unchanged COD.

The supernatant wastewater from the precipitation pond was subjected to the following procedures for treatment: at first, the wastewater entered a pH adjustment pond to adjust pH to be in a range from 7.0 to 7.5; secondly, the wastewater entered an AO (Anaerobic-Oxic) biochemical system to convert macromolecular organic substances in the wastewater into micromolecular organic substances by acidation and hydrolysis actions of facultative bacteria in a facultative pond, after that, the wastewater entered an aerobic pond to convert these micromolecular organic substances into inorganic substances (carbon dioxide and water) by metabolism action of aerobic bacteria, so as to remove the majority of COD in the wastewater; afterwards, the wastewater entered an organic wastewater reaction pond for coagulation precipitation once again and then entered an organic precipitation pond for solid-liquid separation, so as to remove a large number of aging organisms floating in the wastewater, and finally, the wastewater entered a pH back-adjustment pond to ensure pH thereof to be within a discharge control range from 8 to 8.5 and was further discharged as treated wastewater that met the discharge standard. Therefore, copper in the wastewater was effectively treated, where copper content in the wastewater was 0.2 mg/l and COD was 35 mg/1, which met the pollutant discharge standards.

What is claimed is:

1. A method for treating wastewater containing at least one copper complex, comprising:
1) providing the wastewater containing at least one copper complex, wherein the at least one copper complex is chosen from EDTA-Cu²⁺ complex and ammonia-Cu²⁺ complex;
2) adjusting pH of the wastewater containing the at least one copper complex to be within a range from 2.0 to 3.0, and adding ferrous sulfate to convert copper in the wastewater into a form of cuprous ions; and
3) adjusting pH of the wastewater obtained in step 2) to be within a range from 8.0 to 10.5, so that the cuprous ions in the wastewater are converted into precipitates of cuprous hydroxide and/or precipitates of cuprous oxide.

2. The method according to claim 1, wherein in step 3), the pH of the wastewater obtained in the step 2) is adjusted to be within a range from 8.5 to 9.5.

3. The method according to claim 1, wherein in step 3), at least one flocculant is further added to the wastewater after the cuprous ions are converted into the precipitates of cuprous hydroxide and/or the precipitates of cuprous oxide, so that the precipitates obtained in step 3) are flocculated.

4. The method according to claim 3, wherein the at least one flocculant is polyacrylamide.

5. The method according to claim 1, wherein the method further comprises:
4) separating the wastewater from the precipitates obtained in step 3).

6. The method according to claim 5, wherein the method further comprises:
5) adjusting pH of the wastewater obtained in step 4) to be within a range from 6.0 to 9.0, and treating the wastewater by a biochemical treatment system so as to lower the COD (Chemical Oxygen Demand) of the wastewater to 90 mg/l or below.

7. The method according to claim 6, wherein the biochemical treatment system comprises a facultative pond and an aerobic pond.

8. The method according to claim 6, wherein in step 5), the pH of the wastewater obtained in step 4) is adjusted to be within a range from 7.0 to 7.5, and the wastewater is treated by a biochemical treatment system in order to lower the COD of the wastewater to 60 mg/l or below.

9. The method according to claim 1, wherein the method does not use sulfide.

10. The method according to claim 1, wherein the wastewater containing at least one copper complex is wastewater generated in production of a circuit board.
